(19) United States
(12) Patent Application Publication
(10) Pub. No.: US 2004/0266927 A1
(43) Pub. Date: Dec. 30, 2004

(54) Filled blends of tubular reactor produced ethylene/alkyl acrylate copolymers modified with organic acids

(76) Inventors: George Wyatt Prejean, Orange, TX (US); Stephen P. Musemeche, Orange, TX (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/837,739

(22) Filed: May 3, 2004

Related U.S. Application Data
(60) Provisional application No. 60/482,924, filed on Jun. 27, 2003.

(51) Int. Cl. C08L 1/00

(52) U.S. Cl. 524/284; 524/523; 524/425

(57) ABSTRACT

Disclosed are filled and plasticized blends of tubular reactor produced ethylene/alkyl acrylate copolymers modified with organic acids, consisting essentially of (a) from about 1 to about 50% by weight of at least one tubular reactor produced ethylene/alkyl acrylate copolymer; (b) from about 1 to 20 percent by weight of at least one plasticizer selected from the group consisting of processing oils, epoxidized oils, polyesters, polyethers, and polyether esters; (c) from about 40 to about 90% by weight of filler; (d) from about 0.05 to about 5% by weight of at least one organic acid or acid derivative selected from the group consisting of saturated or unsaturated mono- and polycarboxylic acids having from 6 to 54 carbon atoms, and mixtures thereof; and optionally (e) from 0 to about 5% by weight of tackifier.

Also disclosed are sound management sheets that comprise these compositions. Also disclosed are carpets, especially automotive carpets, having backside coatings comprising these compositions.

### CROSS-REFERENCE TO RELATED APPLICATIONS

Applicant claims the benefit of priority to provisional application 60/482,924 filed Jun. 27, 2003; herein incorporated by reference in its entirety.

### BACKGROUND OF THE INVENTION

1. Field of the Invention

The present invention relates thermoplastic sound proofing compositions. More specifically, this invention relates to filled and plasticized blends of tubular reactor produced ethylene/alkyl acrylate copolymers modified with organic acids and their use in making sound-deadening sheet and automotive carpet backing.

2. Description of the Related Art

Certain ethylene copolymers combined with inorganic fillers and modified with, for example, organic acids have been used for sound management purposes such as sound barriers or sound deadening. In general, there are three ways in which sound can be minimized or managed. The sound waves can be blocked, the vibrations can be damped, or the noise can be absorbed. To manage sound in these various ways, articles with different characteristics are required.

U.S. Pat. No. 6,319,969 discloses compositions of ethylene and/or α-olefin/vinyl or vinylidene interpolymers, particularly ethylene/styrene interpolymers, an organic acid and filler.

U.S. Pat. No. 4,434,258 discloses filled thermoplastic compositions obtained by blending about 0-50% by weight of an ethylene interpolymer, such as (among others) ethylene/esters of unsaturated mono- or dicarboxylic acids; 0 to 20% by weight of a plasticizer selected from the group consisting of processing oils, epoxidized oils, polyesters, polyethers, polyether esters and combinations thereof; about 40-90% by weight of filler; from about 0.05 to about 5.0% by weight of at least one organic acid or acid derivative selected from the group consisting of saturated polycarboxylic acids having from 6 to 54 carbon atoms, unsaturated mono- and dicarboxylic acids having from 12 to 20 carbon atoms, alicyclic and aromatic carboxylic acids, and mono-, di- and trivalent metal salts, esters and amides of said acids.

U.S. Pat. No. 4,430,468 discloses similar filled thermoplastic compositions obtained by blending about 0-50% by weight of an ethylene interpolymer, such as (among others) ethylene/esters of unsaturated mono- or dicarboxylic acids; 0 to 20% by weight of a plasticizer selected from the group consisting of processing oils, epoxidized oils, polyesters, polyethers, polyether esters and combinations thereof; about 40-90% by weight of filler; from about 0.05 to about 5.0% by weight of at least one surface active agent such as sulfonates, sulfates, phosphates, and optionally modifying resins, such as tackifiers and certain ethylene and propylene homo- and copolymers.

These patents also describe the above compositions in the form of sound-deadening sheets and carpets having a backside coating of the above compositions.

### BRIEF SUMMARY OF THE INVENTION

It is desirable to combine the sound deadening qualities afforded by filled ethylene copolymers, such as those described above, with better heat resistance. Stability at higher temperatures is important in applications where the sound deadening materials are exposed to high temperatures such as those found in automotive applications and manufacturing facilities.

Tubular reactor produced ethylene/alkyl acrylate and ethylene/alkyl methacrylate copolymers are characterized as having greater comonomer heterogeneity within the polymer, less long chain branching, and higher melting point at equal ester comonomer content than conventional autoclave batch-reactor produced ethylene copolymers. As a consequence of the higher melting points of the tubular reactor produced ethylene/alkyl acrylate and ethylene/alkyl methacrylate copolymers, compositions containing them have higher heat resistance than compositions containing ethylene/alkyl acrylate and ethylene methacrylate copolymers produced in autoclave reactors.

An object of this invention is to provide filled thermoplastic compositions with higher heat resistance than conventional filled thermoplastic compositions.

Accordingly, this invention provides a filled thermoplastic composition consisting essentially of

(a) from about 1 to about 50% by weight of at least one tubular reactor produced ethylene/alkyl acrylate copolymer;

(b) from about 1 to 20 percent by weight of at least one plasticizer selected from the group consisting of processing oils, epoxidized oils, polyesters, polyethers, and polyether esters;

(c) from about 40 to about 90% by weight of filler;

(d) from about 0.05 to about 5% by weight of at least one organic acid or acid derivative selected from the group consisting of saturated or unsaturated mono- and polycarboxylic acids having from 6 to 54 carbon atoms, and mixtures thereof; and optionally

(e) from 0 to about 5% by weight of tackifier,

wherein all weight percents are based on the total weight of components (a) through (e).

When formed into sheets, the filled compositions according to the instant invention, help stop vibration that causes noise. Accordingly, this invention also provides for sound management (i.e. sound deadening) sheets comprising these compositions. This invention further provides for carpets, especially automotive carpets, having backside coatings comprising the above compositions.

### DETAILED DESCRIPTION OF THE INVENTION

As used herein the term “consisting essentially of” means that the named ingredients are essential; however, other ingredients that do not prevent the advantages of the present invention from being realized can also be included.

All references disclosed herein are incorporated by reference.

“Copolymer” means polymers containing two or more different monomers. The terms “dipolymer” and “terpolymer” mean polymers containing only two and three different monomers respectively. The phrase “copolymer of various monomers” and the like means a copolymer whose units are derived from the various monomers.

As used herein, the number of carbon atoms in a chemical moiety is designated by the notation Cₙ, in which n represents the number of carbon atoms present in said moiety.

Thermoplastic Resins

Thermoplastic compositions are polymeric materials that can flow when heated under pressure. Melt index (MI) is the mass rate of flow of a polymer through a specified capillary under controlled conditions of temperature and pressure. Melt indices reported herein are determined according to ASTM 1238 at 190° C. using a 2160 g weight, with values of MI reported in grams/10 minutes.

The tubular reactor produced ethylene/alkyl acrylate copolymer useful in the present invention is a thermoplastic ethylene copolymer derived from the copolymerization of ethylene monomer and at least one alkyl acrylate or alkyl methacrylate comonomer, wherein the alkyl group contains from 1 to 8 carbon atoms. More specifically, the tubular reactor produced ethylene/alkyl acrylate copolymer according to the instant invention is to be distinguished from a more conventional autoclave produced ethylene/alkyl acrylate as generally known in the art. Thus the term or phrase “tubular reactor produced” ethylene/alkyl acrylate copolymer, for purposes of this invention, denotes an ethylene copolymer produced at high pressure and elevated temperature in a tubular reactor or the like, wherein the inherent consequences of dissimilar reaction kinetics for the respective ethylene and alkyl acrylate comonomers is alleviated or partially compensated by the intentional introduction of the monomers along the reaction flow path within the tubular reactor. As generally recognized in the art, such a tubular reactor copolymerization technique will produce a copolymer having a greater relative degree of heterogeneity along the polymer backbone (a more random distribution of comonomers), will tend to reduce the presence of long chain branching and will produce a copolymer characterized by a higher melting point than one produced at the same comonomer ratio in a high pressure stirred autoclave reactor.

The relative amount of the alkyl acrylate comonomer incorporated into the tubular reactor produced ethylene/alkyl acrylate copolymer can, in principle, vary broadly from a few weight percent up to as high as 40 weight percent of the total copolymer or even higher. Similarly, the choice of the alkyl group can, again in principle, vary from a simple methyl group up to an eight-carbon atom alkyl group with or without significant branching. The relative amount and choice of the alkyl group present in the alkyl acrylate ester comonomer can be viewed as establishing how and to what degree the resulting ethylene copolymer is to be viewed as a polar polymeric constituent in the filled thermoplastic composition. Preferably, the alkyl group in the alkyl acrylate comonomer has from one to four carbon atoms and the alkyl acrylate comonomer has a concentration range of from 7 to 30 weight percent of the total tubular reactor produced ethylene/alkyl acrylate copolymer. Most preferably, the methyl acrylate (viewed as the most polar comonomer) is employed at a concentration range of from 20 to 30 weight percent of the total tubular reactor produced ethylene/methyl acrylate copolymer; EMA (20-30% MA). Tubular reactor produced ethylene/alkyl acrylate copolymers of this nature are commercially available under the tradename Elvaloy® AC from E. I. du Pont de Nemours & Company, Wilmington, Del.

To further illustrate and characterize the tubular reactor produced ethylene/alkyl acrylate copolymer according to the instant invention relative to conventional autoclave produced copolymer, the following list of commercially available ethylene/methyl acrylate copolymers with associated melting point data show that tubular EMA resins have considerably higher melting points vs. autoclave EMA's due to a very different MA distribution along polymer chains:

Autoclave Produced Copolymers

Exxon Mobil, N.J.; EMA (21.5 wt % MA) mp=76° C.

Exxon Mobil, N.J.; EMA (24 wt % MA) mp=69° C.

Atofina, France; EMA (20 wt % MA) mp=80° C.

Atofina, France; EMA (24 wt % MA) mp=73° C.

Tubular Reactor Produced Copolymers

Elvaloy® AC1125; DuPont EMA (25 wt % MA) mp=88° C.

Elvaloy® AC1820; DuPont EMA (20 wt % MA) mp=95° C.

For additional discussion regarding the differences between tubular reactor produced and autoclave produced ethylene/alkyl acrylate copolymers, see Richard T. Chou, Mimi Y. Keating and Lester J. Hughes, “High Flexibility EMA made from High Pressure Tubular Process”, Annual Technical Conference—Society of Plastics Engineers (2002), 60^{th} (Vol.

2), 1832-1836. CODEN: ACPED4 ISSN:0272-5223. AN 2002:572809 CAPLUS.

The tubular reactor produced ethylene/methyl acrylate copolymer useful in the present invention can vary significantly in molecular weight as witnessed by tubular reactor produced EMA having a melt index numerically in terms of a fraction up to about ten showing significant improvement in both stiffness and elasticity particularly relative to autoclave produced EMA. The specific selection of the melt index grade of polymer component(s) to be used will be influenced by balancing the onset of improved elastic recovery associated with higher relative molecular weight EMA (such as Elvaloy® AC1125 with a 0.7MI) versus the pragmatic ability to more easily blend with fillers with a relatively lower molecular EMA (such as Elvaloy® AC1820 with an 8MI). However, both the stiffness and the elastic recovery of the compositions according to the instant invention have been observed to improve across a broad melt index range consistent with the view that tubular reactor produced EMA is categorically an elastomer and not merely a plastomer.

Generally from about 5 to about 50% by weight of ethylene/alkyl acrylate copolymer is employed in the composition of the present invention, preferably from about 8 to about 45% by weight, and most preferably from about 15 to about 40% by weight. Of course, compositions containing higher percentages of filler will by necessity contain lower percentages of ethylene/alkyl acrylate copolymer. For example, compositions having 76 weight % filler will contain less than about 24 weight % ethylene/alkyl acrylate copolymer.

A mixture of two or more ethylene/alkyl acrylate copolymers can be used in the blends of the present invention in place of a single copolymer as long as the average values for the comonomer content will be within the range indicated above. Particularly useful properties can be obtained when two properly selected ethylene/alkyl acrylate copolymers are used in blends of the present invention. Of note is a composition of this invention wherein at least one tubular reactor produced ethylene/alkyl acrylate copolymer (i.e. component (a)) comprises two different ethylene/methyl acrylate copolymers. By combining two different properly selected EMA copolymer grades with filler, plasticizer, and an organic acid, modification of the physical properties of the filled composition can be achieved as compared with compositions containing only a single EMA resin grade. Most significantly, by replacing a single EMA grade in a filled blend with an equal amount of a properly selected mixture of two EMA grades, where the mixture has the same weight percent methyl acrylate content and melt index as the single EMA grade replaced, the tensile elongation can be increased substantially.

The actual manufacturing of the tubular reactor EMA as previously stated is preferably in a high pressure, tubular reactor at elevated temperature with additional introduction of reactant comonomer along the tube and not merely manufactured in a stirred high-temperature and high-pressure autoclave type reactor. However, it should be appreciated that similar EMA material can be produced in a series of autoclave reactors wherein comonomer replacement is achieved by multiple zone introduction of reactant comonomer as taught in U.S. Pat. Nos. 3,350,372; 3,756,996; and 5,532,066, and as such these high melting point materials should be considered equivalent tubular reactor ethylene/alkyl acrylate copolymer for purposes of this invention.

Plasticizers

The first group of plasticizer ingredients useful in the composition of the present invention is known as process or processing oil. Three types of processing oils are known: paraffinic, aromatic and naphthenic. None of these are pure; the grades identify the major oil type present.

Paraffinic oils tend to “bleed” from blends. Bleeding is normally not desirable, but could be useful in specialty applications, for example, in concrete forms where mold release characteristics are valued.

On the other hand, naphthenic acid and aromatic oils are nonbleeding when used in proper ratios and are thus preferable for uses such as automotive carpet backside.

Processing oils are also subdivided by viscosity range. “Thin” oils can be as low as 100-500 SUS (Saybolt Universal Seconds) at 100° F. (38° C.). “Heavy” oils can be as high as 6000 SUS at 100° F. (38° C.). Processing oils, especially naphthenic and aromatic oils with viscosity of from about 100 to 6000 SUS at 100° F. (38° C.) are preferred.

The amount of plasticizer, such as the processing oil, present in the composition of the present invention is from about 1 to about 20% by weight, preferably from about 2 to about 15% by weight. Most preferably when using a filler of medium density, such as calcium carbonate, the amount of processing oil is from about 4 to about 10% by weight, and when using a filler of higher density, such as barium sulfate, the amount of processing oil is from about 3 to about 10% by weight.

In some cases, addition of processing oil in an amount of less than about 2% will not have a significant effect. Processing oil in excess of about 10% will cause the melt index to rise rapidly and the blend to become much softer. At extremes, for example, at 70% filler, over 15% oil and less than 15% ethylene/alkyl acrylate, the oil content overwhelms the blend as the amount of ethylene/alkyl acrylate present is not adequate to provide adequate strength for the blend.

In the selection of a processing oil, other factors such as the type of oil selected and its viscosity must be considered. These are discussed in detail in U.S. Pat. No. 4,191,798, incorporated herein by reference.

The second group of plasticizers that are useful in the practice of the present invention is the group comprising epoxidized oils such as epoxidized soybean oil and epoxidized linseed oil.

The third group of plasticizers that are useful are the polyesters, which, in general, are liquid condensation products of a polybasic acid and a polyol. The term “liquid” in the context of the present invention is used to mean pourable at room temperature. The acid component is most often a saturated aliphatic dibasic acid or an aromatic dibasic acid; adipic acid, azelaic acid, phthalic acid, sebacic acid, and glutaric acid, or mixtures thereof. The polyol can be an aliphatic polyol or a polyoxyalkylene polyol, such as ethylene glycol, propylene glycol, 1,4- and 1,3-butane glycol, diethylene glycol, and polyethylene glycol. Preferred polyester compositions would consist of an acid component of which greater than 50% by weight are aliphatic dibasic acids, and a polyol component of aliphatic polyol or even more preferably aliphatic glycol. Most preferred compositions are based on adipic or azelaic acid, and propylene glycol or 1,3- or 1,4-butane glycol. The molecular weight of these plasticizers can vary from a low of a few hundred up to a high of about 10,000. The molecular weight of commercial products is seldom specified. Typically in the trade, the molecular weight range of the product is classified as low, medium, or high. The preferred range of molecular weight for purposes of this invention is that classified as medium.

Mixtures of polyesters with hydrocarbon oils are also effective plasticizers in the present invention. One objective of using such a mixture is to couple the high efficiency of the relatively high cost polyester with the low cost of the hydrocarbon oil. The cost and performance of a compound plasticized with such a mixture can be improved significantly for a given application because properties can be tailored more precisely, or filler levels can be increased.

When used alone, the amount of polyester plasticizer in the composition of the present invention is from about 1 to about 15% by weight, preferably from about 2 to about 12% by weight.

Where a mixture of the polyester plasticizer and a hydrocarbon processing oil is employed, the relative proportions of the two components can be varied over a wide range depending upon performance objectives. Mixtures of plasticizers containing 50% or less of the polyester are preferred for economic reasons, and most preferred are those containing 20% or less of the polyester.

Polyethers and polyether esters are also useful as plasticizers in blends of the ethylene copolymers and fillers described above. In general, polyether plasticizers are oligomers or low molecular weight polymers of alkylene oxides; polymers of ethylene or propylene oxide are the most common types available commercially. These polyethers can be prepared by ring opening polymerization of various cyclic ethers and by polymerization aldehydes, using various types of catalysts, or by acid or base catalyzed polymerization of an alkylene oxide by itself or by alkoxylation of a starting alcohol or the like. Polyethers can be terminated by hydroxyl groups to form the diol (glycol) or, in the case of adducts of alkylene oxides with glycerol, for example, the triol, and so forth. The hydroxyl-terminated polyether can also be reacted with an acid to form the ester. Fatty acids such as lauric and stearic acids are commonly used; the most common examples of these compounds are the mono- and diesters of polyethylene or polypropylene glycol. The molecular weight of polyethers may range up to those typical of high polymers.

Preferred polyether compositions in the practice of this invention are those consisting of the polyols based on random and/or block copolymers of ethylene oxides and propylene oxides. The copolymer polyols provide better performance in terms of efficiency in compounds of the present invention containing very high levels of filler.

When used alone the amount of polyether plasticizer in the composition of the present invention is from about 1 to about 15% by weight, preferably from about 2 to about 12% by weight.

Mixtures of the polyether or the polyether ester plasticizers with either a polyester plasticizer or a hydrocarbon processing oil can also be used in the practice of this invention. The advantage of a polyether/polyester combination is the lower cost since the polyethers are cheaper than the polyesters. Combinations of polyether and processing oil are also cheaper because of the lower cost of the oil.

The relative proportions of the two components in a combination of polyether and polyester can be adjusted according to the efficiency of the system based on property requirements and cost. Those based primarily on polyester will not be as stiff and will be more expensive, for example, than those based primarily on a polyether or polyether ester.

Where a mixture of the polyether or polyether ester and hydrocarbon oil is employed, the relative proportions used will again depend upon cost and property requirements. Since polyethers are more expensive than processing oils, plasticizer mixtures that contain 50% or less of the polyethers are preferred.

As referred to above, a mixture of processing oil, on the one hand, and epoxidized oil, polyester or polyether or polyether ester, or any combination thereof, on the other hand, can also be used as the plasticizer for the compositions of the present invention.

Where a mixture of plasticizers is used, the amount of plasticizer may range from about 2 to about 15% by weight, preferably from about 4 to about 12% by weight. Most preferably when using a filler of medium density, such as calcium carbonate, the amount of plasticizer is from about 5 to about 10% by weight, and when using a filler of higher density, such as barium sulfate, the amount of plasticizer is from about 4 to about 8% by weight.

Plasticizers comprising a processing oil are preferred.

Fillers

The third essential ingredient of the composition of the present invention is the filler, which modifies the density to affect sound deadening. The percentage of filler that can be included in the composition of the present invention on a weight basis is primarily a function of the density of the filler. Particle size and shape of the filler also will have an effect on properties of blends. Fine particle size fillers generally have a tendency to result in higher blend viscosities and they are also more expensive. No. 9 Whiting (about 95% through 325 mesh) represents a viable midpoint in coarseness, availability, and cost. More preferred fillers are calcium carbonate and barium sulfate, and most preferred is calcium carbonate. The amount of filler present in the composition of the present invention is from about 40 to about 90% by weight, preferably from about 50 to about 90% by weight. Most preferably, when using a filler of medium density, such as calcium carbonate, the amount of filler is from about 50 to about 85% by weight, alternatively from about 65 to about 85% by weight, and when using a filler of higher density, such as barium sulfate, the amount of filler is from about 70 to about 90% by weight.

Organic Acids

The final essential ingredient for the compositions of this invention is an organic acid of the proper type. Organic acids over a wide range of saturated acid types, from monobasic saturated carboxylic acids such as caproic acid (C₆) to long-chain fatty acids types such as behenic acid (C₂₂) are effective in enhancing elongation and in increasing melt index at very low concentrations, particularly for compositions with lower percentages of fillers.

Further, mono- or polyunsaturated organic acids, including the C₁₂ to C₂₀ mono- and dicarboxylic acids, and, in particular, oleic acid (a monounsaturated C₁₈ fatty acid), are also effective.

In addition to the acids listed above, saturated polybasic acids, such as azelaic acid (a C₉, saturated, dibasic acid of the formula HOOC(CH₂)₇COOH) are also effective. Thus, the compounder is afforded an added tool for securing a desired balance of properties.

In addition to monomeric organic acids, so-called “dimer” and “trimer” acids (dimers and trimers of the simpler straight-chain forms) having up to 54 carbon atoms are also highly effective, particularly at higher filler loadings. These dimer and trimer acids are derived from mono- or poly-unsaturated acids in which one or more of the olefinic bonds of a monomeric acid molecule reacts with one or more of the olefinic bonds of other monomeric acid molecules to form acyclic, cyclic, aromatic or polycyclic dimers and/or trimers. Typically a mixture of structures results, with cyclic addition products predominating. Of particular note are dimer acids (CAS No. 61788-89-4) and trimer acids (CAS No. 68937-90-6) derived from C₁₈ fatty acids such as linoleic acid. The unsaturated bonds remaining after dimerization or trimerization can be hydrogenated to provide fully saturated dimers (CAS No. 68783-41-5) or fully saturated trimers. Dimer and trimer acids can be obtained from Arizona Chemical Company, Panama City, Fla. under the Unidyme® tradename.

Mixtures of the above-mentioned acids can be employed in compositions of this invention, as can mixtures of any of the acid types disclosed herein. Of particular note is a mixture of dimer and trimer acids, as described above, containing at least 51% and typically 55% trimer acids (measured by gas chromatography) obtained from Arizona Chemical Company, Panama City, Fla. as Unidyme® 60.

Mono-, di- and trivalent metal salts of organic acids, in particular the calcium and zinc salts of fatty acids, are effective in carrying out the purposes of this invention.

The number of organic acids in existence is enormous; the examples named above can be replaced by other close analogs with good results and without departing from the spirit of this invention.

Preferred organic acids are selected from the group consisting of saturated or unsaturated mono-, di- and tricarboxylic acids having from 6 to 54 carbon atoms, including dimer and trimer acids, and zinc and calcium salts of said acids.

Although any of the preferred organic acids can be used throughout the range of filler amounts, certain organic acids may be preferred for preparing compositions in certain ranges of filler amounts. For example, for lower amounts of filler, such as amounts from about 40 to about 65 weight %, alternatively from about 40 to about 55 weight %, more preferred organic acids are selected from the group consisting of palmitic, stearic and oleic acids, and mixtures of these acids, with stearic acid even more preferred. Of particular note is a composition of this invention comprising 50 weight % of CaCO₃, containing stearic acid.

Of note are compositions of this invention comprising amounts of filler from about 65 to about 90 weight % of CaCO₃, alternatively from about 55 to about 90 weight %, containing organic acids selected from the group consisting of palmitic, stearic and oleic acids, and mixtures of these acids. Also of note is a composition of this invention comprising 76 weight % of CaCO₃, containing stearic acid.

For higher amounts of filler, such as amounts from about 65 to about 90 weight %, alternatively from about 55 to about 90 weight %, more preferred organic acids are selected from the group consisting of dimer and trimer acids, and mixtures of these acids. Of note are compositions of this invention comprising from about 65 to about 90 weight % of CaCO₃, alternatively from about 55 to about 90 weight %, containing organic acids selected from the group consisting of dimer and trimer acids, and mixtures of these acids. Of particular note is a composition of this invention comprising 76 weight % of CaCO₃, containing organic acids selected from the group consisting of dimer and trimer acids, and mixtures of these acids, especially wherein the dimer and trimer acids are derived from linoleic (C₁₈) acid.

Of note are compositions of this invention comprising amounts of filler from about 40 to about 65 weight % of CaCO₃, alternatively from about 40 to about 55 weight %, containing organic acids selected from the group consisting of dimer and trimer acids, and mixtures of these acids.

In using organic acids of the types described in the compositions of this invention the amount is from about 0.05 to about 5% by weight, and preferably from about 0.1 to about 2%. Most preferably, when using a fatty acid or a dimer or trimer acid, the amount is from about 0.12% to about 0.65%.

Polymers, both homo- and copolymers, other than the ones referred to above, can also be used to some extent in combination with the above specified polymers without significantly interfering with the advantages obtained by the present invention. These include, but without limitation, polymers such as ethylene/carbon monoxide and ethylene/sulfur dioxide. Similarly other ingredients can also be added to the compositions of the present invention by a compounder in order to obtain some desired effect, such as reduction of cost, or enhancement of a physical property. Accordingly, extender resins, waxes, foaming agents, crosslinking agents, antioxidants, etc., that are widely used, particularly in hot melts, can be included in the compositions of the present invention. Illustrative examples of several special additives and of potentially desirable resin ingredients are given below.

The basic blends described above are essentially free of surface tack at ambient temperature. Even if made with a “bleeding” type of paraffinic oil, the final sheet, at ambient temperature, may be slippery to the touch but will not be tacky. (Of course, as temperatures are increased to the 200° F. to 250° F. level, the blends will be progressively softened and will adhere well to many substrates.) From time to time, compounders probably will want to produce sheeting with enhanced surface tack or adhesiveness. This can be done in the blends described in the present invention by incorporating a tackifier resin in the formulation. The tackifier may be any suitable tackifier known generally in the art such as those listed in U.S. Pat. No. 3,484,405. Such tackifiers include a variety of natural and synthetic resins and rosin materials. The resins that can be employed are liquid, semi-solid to solid, complex amorphous materials generally in the form of mixtures of organic compounds having no definite melting point and no tendency to crystallize. Such resins are insoluble in water and can be of vegetable or animal origin, or can be synthetic resins. The resins can provide substantial and improved tackiness of the composition. Suitable tackifiers include, but are not necessarily limited to the resins discussed below.

A class of resin components which can be employed as the tackifier composition hereof, are the coumarone-indene resins, such as the para-coumarone-indene resins. Generally the coumarone-indene resins that can be employed have a molecular weight that ranges from about 500 to about 5,000. Examples of resins of this type that are available commercially include those materials marketed as “Picco”-25 and “Picco”-100.

Another class of resins that can be employed as tackifiers useful in this invention is the terpene resins, including also styrenated terpenes. These terpene resins can have a molecular weight range from about 600 to 6,000. Typical commercially available resins of this type are marketed as “Piccolyte” S-100, as “Staybelite Ester” #10, which is a glycerol ester of hydrogenated rosin, and as “VVingtack” 95, which is a polyterpene resin.

A third class of resins that can be employed as the tackifier are the butadiene-styrene resins having a molecular weight ranging from about 500 to about 5,000. A typical commercial product of this type is marketed as “Buton” 100, a liquid butadiene-styrene copolymer resin having a molecular weight of about 2,500. A fourth class of resins that can be employed as the tackifier in this invention are the polybutadiene resins having a molecular weight ranging from about 500 to about 5,000. A commercially available product of this type is that marketed as “Buton” 150, a liquid polybutadiene resin having a molecular weight of about 2,000 to about 2,500.

A fifth class of resins that can be employed as the tackifier are the so-called hydrocarbon resins produced by catalytic polymerization of selected fractions obtained in the refining of petroleum, and having a molecular weight range of about 500 to about 5,000. Examples of such resin are those marketed as “Piccopale”-100, and as “Amoco” and “Velsicol” resins. Similarly, polybutenes obtained from the polymerization of isobutylene may be included as a tackifier.

The tackifier may also include rosin materials, low molecular weight styrene hard resins such as the material marketed as “Piccolastic” A-75, disproportionated pentaerythritol esters, and copolymers of aromatic and aliphatic monomer systems of the type marketed as “Velsicol” WX-1232. The rosin that may be employed in the present invention may be gum, wood or tall oil rosin but preferably is tall oil rosin. Also the rosin material may be modified rosin such as dimerized rosin, hydrogenated rosin, disproportionated rosin, or esters of rosin. Esters can be prepared by esterifying the rosin with polyhydric alcohols containing from 2 to 6 alcohol groups.

A more comprehensive listing of tackifiers, which can be employed in this invention, is provided in the TAPPI CA Report #55, February 1975, pages 13-20, inclusive, a publication of the Technical Association of the Pulp and Paper Industry, Atlanta, Ga., which lists well over 200 commercially available tackifier resins.

In use, the compounder generally will want to select an ethylene-based copolymer and a tackifier resin that will be mutually compatible; chemical similarities that will indicate compatibility can be used for guidance. For a few highly specialized uses, such as super-hot-tack, quick-stick blends, the compounder may well elect to use incompatible systems. Finally, the reverse effect may be sought—in such instances, where an unusually slippery surface is desired, incorporation of small amounts of a slip aid such as Armid O may prove beneficial.

In using tackifier resins, the amount used in compositions of this invention is from 0 to about 5% by weight of the blend.

The teachings above have dealt with several different potential polymeric ingredients on an “individual-ingredient” basis to outline contributions possible from widely varying resin or polymer types. It must be stressed that polymer ingredients of the above types can, of course, be mixed so that, for example, the compounder may elect to modify a simple four-component composition (i.e. tubular reactor produced EMA/oil/filler/fatty acid) by replacing part of the tubular reactor produced EMA with a small amount of tackifier for adhesivity. In addition, part of the oil can be replaced with a polyester or polyether-type additive to attain highly effective plasticization with a lower total amount of plasticizer. Thus, the possible combinations and permutations available to a skilled compounder will be infinite, yet remain within the spirit and intent of this invention.

The blends of the present invention are thermoplastic in nature and therefore can be recycled after processing. The recycled material may also contain textile fibers, jute, etc. present in the trim obtained during production of the finished product (e.g., back-coated automotive carpet).

Preferred are compositions of this invention wherein component (a) comprises two different ethylene/methyl acrylate copolymers; the plasticizer of component (b) is a processing oil; the filler of component (c) is calcium carbonate; and the organic acid of component (d) is selected from the group consisting of saturated or unsaturated mono-, di- and tricarboxylic acids having from 6 to 54 carbon atoms, including dimer and trimer acids, and mixtures thereof.

Preferred are the above preferred compositions wherein said calcium carbonate is present in amounts from about 40 to about 65 weight %, and said organic acid is selected from the group consisting of palmitic, stearic and oleic acids, and mixtures thereof. Further preferred is a composition comprising 50 weight % of CaCO₃ and wherein the organic acid is stearic acid.

Also preferred are the above preferred compositions wherein said calcium carbonate is present in amounts from about 65 to about 90 weight %, and said organic acid is selected from the group consisting of dimer and trimer acids, and mixtures of these acids. Further preferred is a composition comprising 76 weight % of CaCO₃ and wherein said dimer and trimer acids are derived from linoleic (C₁₈) acid.

Compositions of this invention may comprise other optional additives such as conventional additives used in polymeric materials including, for example, carbon black, which is used as a coloring agent or filler; titanium dioxide, which is used as a whitening agent or filler; other pigments; dyes; optical brighteners; surfactants; stabilizers such as antioxidants, ultraviolet ray absorbers, and hydrolytic stabilizers; anti-static agents; fire-retardants; lubricants; reinforcing agents such as glass fiber and flakes; antiblock agents; release agents; processing aids; and/or mixtures thereof.

A commercially sized batch-type Banbury or equivalent intensive mixer is suitable for preparing the compositions of the present invention. A Farrel continuous mixer (“FCM”) is also a suitable mixing device. In either instance, dry ingredients are charged in routine fashion. It is convenient in most cases to inject the plasticizer component directly into the mixing chamber of either unit as per widely used practice with this type of equipment. When more than one plasticizer is used, and where any one of the plasticizers is present in a small amount (less than about 10 weight percent of the total plasticizer mixture), the plasticizers should be blended before addition to the other ingredients used in the filled compositions. This will facilitate uniform distribution of each plasticizer component in the final composition and thus ensure that optimum properties are obtained. Similarly, since the amounts of organic acid employed generally are so small (less than 1% for many cases), it is important to be certain that the organic acid is thoroughly mixed into the final blend. If this is not done, highly erratic values for physical properties may result. Thus, it may often prove helpful to premix the organic acid into a portion of one of the other ingredients, e.g., a liquid organic acid may be premixed with the process oil or a solid organic acid may be premixed with an aliquot of the filler. If desired, the copolymer and the plasticizer(s) can be precompounded as a “masterbatch” in a suitable intensive mixing device (e.g., Banbury mixer or screw extruder). This “masterbatch” can then be compounded with the filler and the other remaining ingredients to produce the final composition. A mix cycle of about 3 minutes is generally adequate for the Banbury mixer at an operating temperature ranging typically from about 325° F. to about 375° F. The operating rate for the FCM unit generally will fall within ranges predicted by literature prepared by the Farrel Company, Ansonia, Conn. Here, temperatures ranging typically from about 325° F. to about 425° F. are effective. In both cases, a very low plasticizer level, for example about 2 to 3%, may require higher temperatures, while plasticizer levels above about 7% may mix well at lower mixer temperatures. While not evaluated, it is expected that other devices for handling viscous mixes (MI of 0.1 to 20) should be entirely satisfactory.

Generally, changes in the sequence of addition of ingredients have not been found to be significant, provided that the final mixture is thoroughly fluxed to attain homogeneity.

Once blends are mixed, routine commercial practices may be used, such as underwater melt cutting plus drying or use of sheeting plus chopping methods, to produce a final composition in pellet form. Alternately, the hot mixture also may be immediately fabricated into a final form, e.g. sheeting, molding, etc.

The highly-filled compositions described herein may be processed industrially into final sheet, film or three-dimensional solid form by using standard fabricating methods well known to those skilled in the art. Thus, fabricating methods such as extrusion, calendering, injection or rotomolding, extrusion coating, sheet laminating, sheet thermoforming, etc. are all practical means for forming the compositions of this invention.

Sheet articles are typically extruded in one step and often subjected to thermoforming, such as for example described in U.S. Pat. No. 4,386,187, which is incorporated herein in its entirety by reference. Film articles can be prepared by extrusion and thermoforming, but also by casting or film blowing. Blown films require the copolymer by itself, or a relatively homogeneously mixed copolymer-polymer blend for the polymer component of the composition, which preferably is prepared in a separate step.

The blends of the present invention can readily be extruded onto a substrate, such as automotive carpet, foam, fabric or scrim material, or can be extruded or calendered as unsupported film or sheet. Depending upon the equipment used, and the compounding techniques employed, it is possible to extrude a wide range of film thickness, from below 20 mils to above 100 mils. Accordingly, this provides industry with an opportunity to vary the amount of sound deadening to be attained by varying film thickness, density of blends, ratio of filler load to binder, and similar techniques well known in the art.

As sound management articles, the highly filled compositions are useful in sound dampening components for automotive and other applications. The level of filler that these blends can bind without unacceptable degradation of the physical properties is significantly higher than many other polymers, particularly at higher temperatures.

The compositions of the present invention, when employed in sound barrier layer applications, are often used in conjunction with a decoupling layer of foam or fibrous felt. The high density of the compositions of the present invention itself acts as a barrier to the transmission of sound vibrations. In addition, use of a decoupling layer (in conjunction with said high density barrier layer) prevents the direct transmission of sound vibrations from the substrate through the barrier layer (which would occur if the sound barrier layer were directly affixed to the substrate). The sound barrier layer usually has a density of between 1.5 and 2.6 g/cm³. The sound barrier composition of this invention can be calendered or extruded into a sheet prior to thermoforming to fit the contours of the vehicle, appliance or other structure to which it is applied. The barrier layer may then be laminated with the foam or fiber layer, and is often also layered with a carpet or other decorative layer. The substrate is the material of construction of the article for which sound management is required and typically comprises one or more materials selected from metal, plastic, glass, natural fibers, synthetic fibers, and wood.

Primary use for the compositions of the present invention will probably be in the sheeting field, particularly for low cost, dense, sound-deadening structures. Outstanding characteristics such as improved “hand”, “drape”, reduced stiffness, higher elongation, reduced thickness and especially improved heat resistance and better thermal stability of the extruded sheeting result from the compositions of the present invention.

The filled thermoplastic compositions of this invention have many sound management uses including, but not limited to, extruded sheet to be used as a moldable sound barrier in sound deadening applications including transport systems such as automobiles, motorcycles, buses, tractors, trains, trams, airplanes, and the like. The sound-deadening sheet comprising a composition of this invention may be used in various ways:

When applied to automotive carpet, blends described are an effective and economic means to deaden sound, while also simultaneously serving as a moldable support for the carpet. The application of the compositions of the present invention in carpets, and particularly in automotive carpets, is essentially identical to methods already described in U.S. Pat. No. 4,191,798, the disclosure of which is hereby incorporated by reference.

When used in sheet form, especially when coated onto a fabric, the blends can be installed in other areas of an automobile, truck, bus, etc., such as side panels, door panels, roofing areas, headliners and dash insulators. The compositions of this invention may also be used in automotive door and truck liners, rear seat strainers, wheel well covers, carpet underlayments, dash mats, sound damped automotive enclosures such as oil pans, disc brake pads, mufflers, etc.

In sheet form, the highly filled blends may be used as drapes or hangings to shield or to surround a noisy piece of factory equipment such as a loom, a forging press, conveyor belts and material transfer systems, etc.

The compositions of this invention may be used for sound deadening in small and large appliances, including dishwashers, refrigerators, air conditioners, and the like; household items such as blender housings, power tools, vacuum cleaning machines, and the like; lawn and garden items such as leaf blowers, snow blowers, lawn mowers, and the like; small engines used in boating applications such as outboard motors, water-jet personal watercraft, and the like. Additional applications include devices for modifying the sound of a drum, loudspeaker systems, acoustically damped disc drive systems, and the like.

In construction and building industries, compositions of this invention may be used as wallpapers/coverings, composite sound walls, thermoformable acoustical mat compositions, vibration-damping constrained-layer constructions, and sound insulation moldable carpets. In laminated sheet form, the blends, faced with another material, can be used to achieve both a decorative and a functional use, such as dividing panels in an open-format office.

Preferred sound-deadening sheets and preferred carpets comprise the preferred compositions described above.

Other uses are possible. An advantage of the blends of this invention is that certain physical properties, such as flexibility and toughness, which are typically reduced when fillers are added to polymers, can be maintained within useful limits over a broad range of filler concentrations. As noted above, the improved heat resistance and better thermal stability afforded by the tubular reactor produced ethylene/alkyl acrylate copolymer is particularly advantageous. Thus, blends of this invention could be used in the manufacture of wire and cable components in a variety of electronic, telecommunications and similar areas, of various molded parts, of sealants and caulks, or in other uses where flexibility, toughness and heat resistance and better thermal stability are desired, coupled with the economies normally achieved by the incorporation of low cost fillers.

The following Examples are presented to more fully demonstrate and further illustrate various aspects and features of the present invention. As such, the showings are intended to further illustrate the differences and advantages of the present invention but are not meant to be unduly limiting.

General Procedures for Examples:

The Examples that follow are given for the purpose of illustrating the present invention. All parts and percentages are by weight unless otherwise specified.

In all Examples, the ingredients were premixed in a one-gallon (about 3.8 Liter) can by shaking the contents manually for about 0.5 minutes. (Where liquid fatty acids are employed, it is often preferably to premix the very small amount of acid into the much larger volume of liquid plasticizer, separately, before adding the liquid to the one-gallon can, to ensure reaching homogeneity rapidly). The ingredients were then added to a Banbury-type laboratory-sized intensive high-shear mixer. Mix conditions used were fluxing for 3 minutes, at a temperature ranging from about 325° F. to about 375° F. (from about 160° C. to about 190° C.).

Testing Criteria for Examples:

Melt Index (MI) was measured in accord with ASTM D-1238, condition E, at 190° C., using a 2160-gram weight, with values of MI reported in grams/10 minutes. Density was determined in accord with ASTM D-792. DSC Melting point (m.p.) was determined in accord with ASTM D-3418. Vicat softening point was determined in accord with ASTM D-1525. Shore A hardness was determined in accord with ASTM D-2240.

Without further elaboration, it is believed that one skilled in the art using the preceding description can utilize the present invention to its fullest extent. The following Examples are, therefore, to be construed as merely illustrative, and not limiting of the disclosure in any way whatsoever.

### EXAMPLES AND COMPARATIVE EXAMPLES

Materials Used

EMA-1: Tubular reactor produced ethylene/24% methyl acrylate copolymer having MI of 2.0, density of 944 kg/M³, melting point of 91° C. and Vicat softening point of 48° C.

EMA-2: Tubular reactor produced ethylene/20% methyl acrylate copolymer having MI of 8.0, density of 942 kg/m³, melting point of 92° C. and Vicat softening point of 54° C.

EMA-3: Tubular reactor produced ethylene/18% methyl acrylate copolymer having MI of 2.0, density of 840 kg/m³, melting point of 94° C. and Vicat softening point of 60° C.

Stearic Acid (octadecanoic acid), a monocarboxylic acid, CH₃(CH₂)₁₆—COOH, molecular weight of 284.49, density 0.94 g/cm³, melting point of 70° C., commercial grade available under the trade name Industrene® B from Crompton Corporation.

Dimer/Trimer Acid Blend, as described above, containing at least 51% and typically 55% trimer acids (measured by gas chromatography) available from Arizona Chemical Company, Panama City, Fla. as Unidyme® 60.

D3000 oil, a naphthenic processing oil having SUS Viscosity at 210° F.=128 (Saybolt Universal Seconds), Flash Point=510° F., Initial Boiling Point=830° F. and Ford Fog Value=80%, available from Ergon.

BLK CON, carbon black dispersed in polyethylene, used as a colorant, available under the tradename Polyone® 2447.

CaCO₃, filler, molecular weight of 100.9, density 2.93 g/cm³, decomposition temperature of about 825° C., commercial grade.

TABLE 1

| Component (wt. %) | Ex. 1 | Ex. 2 | Ex. 3 |
|---|---|---|---|
| EMA-1 | 29.2 | 9.3 | 9.3 |
| EMA-2 | 15.0 | 0 | 0 |
| EMA-3 | 0 | 9.0 | 9.0 |
| Stearic Acid | 0.4 | 0.6 | 0 |
| Dimer/Trimer Acid Blend | 0 | 0 | 0.6 |
| D3000 oil | 5.0 | 4.7 | 4.7 |
| BLK CON | 0.4 | 0.4 | 0.4 |
| CaCO₃ | 50.0 | 76 | 76 |

Comparative Example C1 is included to illustrate the properties of a typical commercially available filled thermoplastic composition. This is a 50% CaCO₃-filled ethylene/vinyl acetate blend.

EVA-1: Ethylene/33% vinyl acetate having MI of 43, density of 0.957 g/cm³, and Vicat softening point of 36° C.

EVA-2: Ethylene/28% vinyl acetate having MI of 6, density of 0.955 g/cm³, and Vicat softening point of 46° C.

### Comparative Example C1

| Component | Weight % |
|---|---|
| EVA-1 | 31.8 |
| EVA-2 | 16.4 |
| Stearic acid | 0.30 |
| BLK CON | 1.5 |
| CaCO₃ | 50.0 |

TABLE 2

| | Ex. 1 | | | | | |
|---|---|---|---|---|---|---|
| Property | Lot 1 | Lot 2 | Lot 3 | Ex. 2 | Ex. 3 | Comp. Ex. C1 |
| Mean break elongation (%) | 620 | 648 | 608 | 95 | 318 | 732 |
| Mean U.T. strength (%) | 538 | 648 | 581 | 265 | 222 | 722 |
| Yield strength (psi) | 524 | 634 | 552 | 265 | 222 | 237 |
| DSC m. p. (° C.) | 89.5 | 89.1 | 90.6 | 89.6 | 89 | 66.75 |
| Melt index | 4.73 | 4.77 | 4.14 | 2.26 | 1.59 | 10.7 |
| Shore A hardness | 85 | 85 | 85 | 95 | 94 | 84 |
| Flex modulus (psi) | 6945 | 6935 | 6592 | 22244 | 17178 | 5044 |

Inspection of the properties summarized in Table 2 shows that the use of tubular reactor produced ethylene/alkyl acrylate provides filled compositions with high heat resistance (melting points above 85° C.). Example 1 exhibits excellent elongation. Example 3 shows that the use of a Dimer/Trimer Acid Blend provides excellent elongation and good flexibility for a highly filled composition.

Having thus described and exemplified the invention with a certain degree of particularity, it should be appreciated that the following claims are not to be so limited but are to be afforded a scope commensurate with the wording of each element of the claim and equivalents thereof.

We claim:

1. A filled thermoplastic composition consisting essentially of
(a) from about 1 to about 50% by weight of at least one tubular reactor produced ethylene/alkyl acrylate copolymer;
(b) from about 1 to 20 percent by weight of at least one plasticizer selected from the group consisting of processing oils, epoxidized oils, polyesters, polyethers, and polyether esters;
(c) from about 40 to about 90% by weight of filler;
(d) from about 0.05 to about 5% by weight of at least one organic acid or acid derivative selected from the group consisting of saturated or unsaturated mono- and polycarboxylic acids having from 6 to 54 carbon atoms, and mixtures thereof; and optionally
(e) from 0 to about 5% by weight of tackifier,
wherein all weight percents are based on the total weight of components (a) through (e).

2. The composition of claim 1 wherein the alkyl group in said alkyl acrylate has from one to four carbon atoms and the alkyl acrylate has a concentration range of from 7 to 30 weight percent of the total tubular reactor produced ethylene/alkyl acrylate copolymer.

3. The composition of claim 2 wherein said alkyl acrylate is methyl acrylate and is employed at a concentration range of from 20 to 30 weight percent of the total tubular reactor produced ethylene/methyl acrylate copolymer.

4. The composition of claim 3 wherein component (a) comprises two different ethylene/methyl acrylate copolymers.

5. The composition of claim 1 wherein said plasticizer comprises a processing oil.

6. The composition of claim 1 wherein component (a) comprises two different ethylene/methyl acrylate copolymers; the plasticizer of component (b) is a processing oil; the filler of component (c) is calcium carbonate; and the organic acid of component (d) is selected from the group consisting of saturated or unsaturated mono-, di- and tricarboxylic acids having from 6 to 54 carbon atoms, including dimer and trimer acids, and mixtures thereof.

7. The composition of claim 6 wherein said calcium carbonate is present in amounts from about 40 to about 65 weight %, and said organic acid is selected from the group consisting of palmitic, stearic and oleic acids, and mixtures thereof.

8. The composition of claim 7 comprising 50 weight % of CaCO₃ and wherein said organic acid is stearic acid.

9. The composition of claim 7 wherein said calcium carbonate is present in amounts from about 65 to about 90 weight %, and said organic acid is selected from the group consisting of dimer and trimer acids, and mixtures of these acids.

10. The composition of claim 9 comprising 76 weight % of CaCO₃ and wherein said dimer and trimer acids are derived from linoleic (C₁₈) acid.

11. A sound-deadening sheet comprising a composition of claim 1.

12. A carpet having a backside coating comprising a composition of claim 1.
